(19) United States
(12) Patent Application Publication
(10) Pub. No.: US 2006/0072283 A1
(43) Pub. Date: Apr. 6, 2006

(54) Uninterruptible power supply with integral applications processor

(76) Inventors: James G. Thompson, Raleigh, NC (US); Brian R. Young, Raleigh, NC (US)

Correspondence Address: Robert M. Meeks;Myers Bigel Sibley & Sajovec, P.A., Post Office Box 37428, Raleigh, NC, 27627, US

(21) Appl. No.: 10/950,731

(22) Filed: Sep. 27, 2004

(51) Int. Cl. H02B 1/00

(52) U.S. Cl. 361/600

(57) ABSTRACT

A UPS includes power supply circuitry configured to selectively provide power to an external load from a plurality of power sources. An applications processor is integrated within the UPS, powered by the power supply circuitry, and configured to provide an operating system that supports loading and execution of externally-supplied applications, such as mission-critical network and/or control applications. The applications processor may be configured to provide a communications interface for the UPS, and may be operative to load applications via the communications interface. In further embodiments, a circuit card may be configured to be installed in a UPS and includes an applications processor configured to provide an operating system that supports loading and execution of externally supplied applications.

### BACKGROUND OF THE INVENTION

The present invention relates to power supply apparatus, and more particularly, to uninterruptible power supplies.

Uninterruptible power supplies (UPSs) are commonly used to provide conditioned, reliable power for computer networks, telecommunications networks, medical equipment and the like. UPSs are widely used with computers and similar computing devices, including but not limited to personal computers, workstations, mini computers, network servers, disk arrays and mainframe computers, to insure that valuable data is not lost and that the device can continue to operate notwithstanding temporary loss of an AC utility source. AC UPSs typically provide AC power to such electronic equipment from a secondary source, such as a battery, in the event that a primary AC utility source drops out (blackout) or fails to provide a proper voltage (brownout). Similar UPS devices may be used in telecommunications applications to provide uninterrupted DC power to network equipment.

Conventional UPSs are typically fixed-state machines that are designed to support one task—the provision of uninterrupted power to an external load. UPSs may include a control processor, e.g., a microprocessor and associated memory, which monitors and controls the UPS's power conversion circuitry. This processor typically has a fixed operating program that controls the UPS functionality, e.g., a program that monitors voltages and currents and responsively controls power conversion circuits. A UPS may also include an external communications interface that provides control and monitoring functions related to these power conversion functions. For example, operating states of the UPS may be monitored via such an interface and/or operating parameters (e.g, shutdown times, power quality criteria, alarm parameters) for power control operations of the UPS may be externally controlled via such an interface. For example, Powerware® Corporation's Multi-Server, Modbus®, and ConnectUPS™ cards, which are connectivity cards designed to interface with the internal bus of a Powerware® UPS, may be used to provide such monitoring and control functions.

### SUMMARY OF THE INVENTION

According to some embodiments of the invention, a UPS includes power supply circuitry configured to selectively provide power to an external load from a plurality of power sources. An applications processor is integrated within the UPS, powered by the power supply circuitry, and configured to provide an operating system that supports loading and execution of externally-supplied applications, such as mission-critical network and/or control applications. The applications processor may be configured to provide a communications interface for the UPS, and may be operative to load applications via the communications interface.

In further embodiments of the invention, a circuit card is configured to be installed in a UPS and includes an applications processor configured to provide an operating system that supports loading and execution of externally supplied applications. The applications processor may be configured to provide a communications interface for the UPS, e.g., the card may include a network connector and associated circuitry that supports the communications interface. The applications processor may be further operative to communicate with a power supply control processor of the UPS, e.g., the circuit card may include a connector configured to be connected to a control bus of the UPS, and the applications processor may be configured to communicate with the power supply control processor via the control bus.

### BRIEF DESCRIPTION OF THE DRAWINGS

FIGS. 1-2 are schematic diagrams illustrating UPSs with integral applications processors according to various embodiments of the invention.

FIGS. 3 and 4 are schematic diagrams illustrating use of UPSs with integral applications processors in mission-critical applications according to further embodiments of the invention.

FIG. 5 is a perspective view of a UPS with a removable applications processor card according to further embodiments of the invention.

FIG. 6 is a perspective view of the applications processor card of FIG. 5.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “UPS” includes all devices capable of selectively providing uninterrupted power to an external load from two or more power sources. Accordingly, “UPSs” include, but are not limited to, power supply devices that are configured to selectively provide AC power to electronic and/or electrical equipment from a primary source, such as a utility line, and a secondary source, such as a battery and/or generator. UPSs also include power supply devices that are configured to provide DC power to electronic and/or electrical equipment from two or more sources. It will be understood that “selective” provision of power by a UPS includes, but it not limited to, alternately supplying power from selected sources, as well as concurrently supplying power from multiple sources, e.g., supplementing and/or conditioning AC utility power using a battery or other supplemental source to meet predetermined power quality criteria. Thus, for example, UPSs, as referred to herein, include, but are not limited to, power supply apparatus that operate in standby, line-interactive and/or on-line modes.

Some embodiments of the invention arise from a realization that modification of the conventional UPS paradigm—that UPSs are merely power supply devices—may provide for more efficient high-availability computing/control solutions. In particular, a conventional paradigm for high availability applications involves the provision of a computer (e.g., a PC, server, workstation, or similar device) that has an operating system (e.g., Linux or Windows@) upon which the high-availability application executes, and a separate, relatively “dumb” UPS, that provides uninterrupted power to the computer. While such absolution may be effective in terms of availability, it may result in high cost (e.g., due to duplication of hardware, such as fans, power supplies, etc.), low computing efficiency (e.g., the computer may be oversized for the task), low power efficiency (e.g., due to increased dissipation in the redundant components), and/or an unwieldy (e.g., unnecessarily large) form factor. According to some embodiments of the invention, such disadvantages may be avoided or reduced by providing a UPS with an integrated applications processor that is robustly powered by uninterruptible power supply circuitry of the UPS and that is configured to provide an operating system, such as Linux, Unix, Windows or a derivative thereof, that supports loading and execution of applications. Thus, for example, such an enhanced UPS may be used to provide high-availability applications, e.g., security or network monitoring applications, without a need for a separate computer.

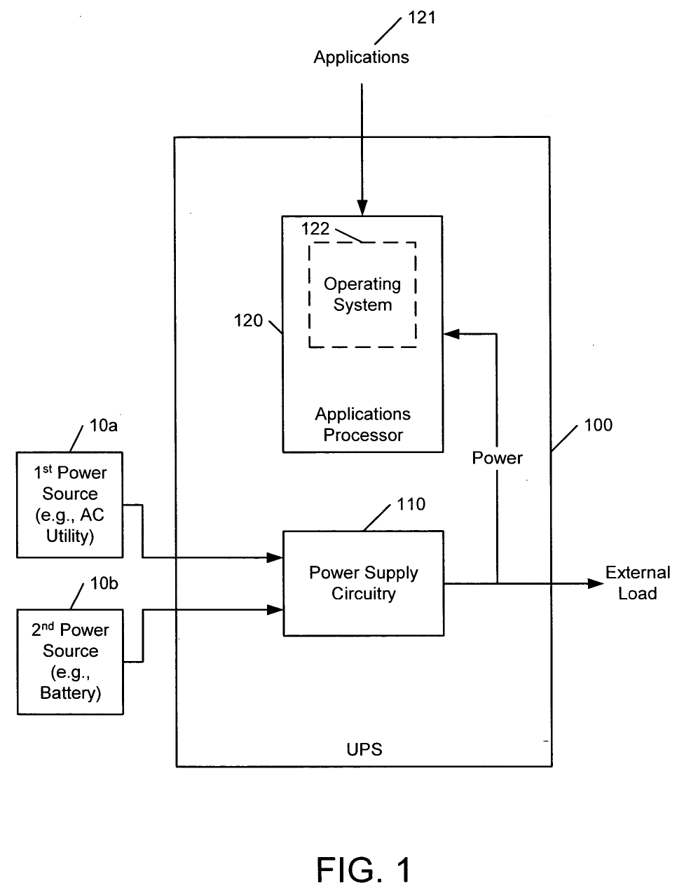

FIG. 1 illustrates a UPS 100 according to some embodiments of the invention. The UPS 100 includes uninterruptible power supply circuitry 110 configured to selectively provide power to an external load from a first and second power sources 10a and 10b, e.g., an AC utility and a battery. It will be appreciated that the power supply circuitry 10 may provide AC and/or DC power, and may operate in any of a number of different modes, e.g., on-line, standby, and/or line interactive. Preferably, the power supply circuitry 110 has an external load capacity greater than or equal to 100 VA AC (or 100 W DC), i.e., a capacity in keeping with typical commercially available UPSs.

The UPS 100 further includes an applications processor 120 integrated within the UPS 100 and powered by the power supply circuitry 1 10. The applications processor 120 may include, for example, a microprocessor or other general purpose computing device, plus associated circuitry, such as memory, mass data storage and/or input/output circuitry. The applications processor 120 is configured to provide an operating system 122, such as Linux, Unix, Windows® or the like, that supports loading of externally-supplied applications 121, and execution thereof on the applications processor 120. The applications 121 that may be loaded onto the applications processor 120 include any of a wide variety of applications, including, for example, network monitoring (e.g., packet sniffing, data integrity checking), security, data logging, and control applications. It will be understood that, although the operating system 122 may be a standard, general-purpose operating system, the operation system 122 may also be customized to the UPS operating environment, e.g., may include application programming interfaces (APIs) specifically oriented to a UPS environment in combination with more general-purpose operating system functions (e.g., input/output, scheduling, etc).

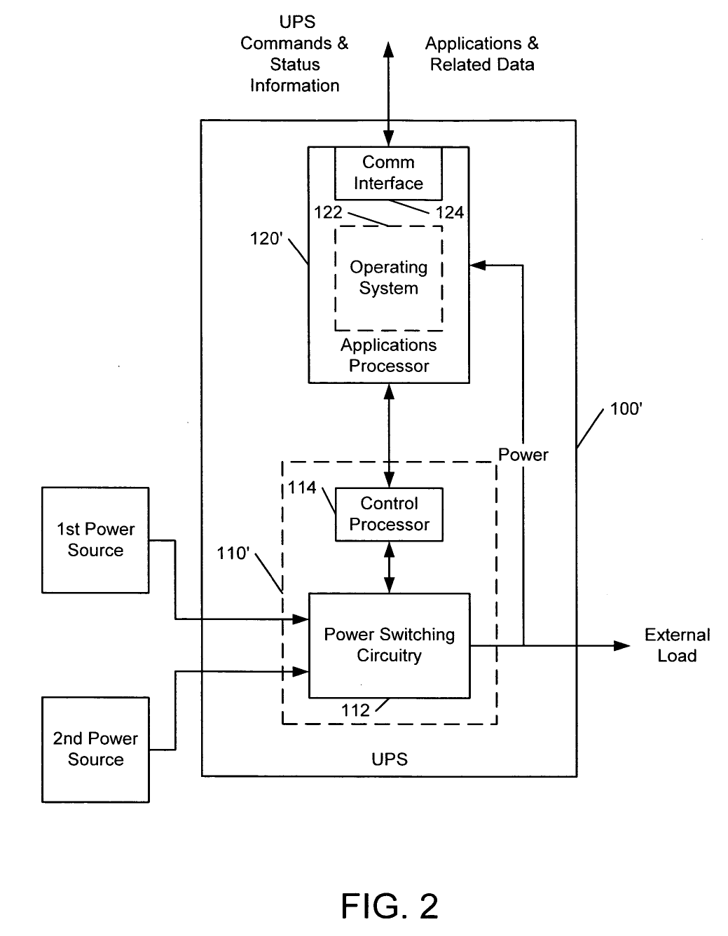

FIG. 2 illustrates a UPS 100′ with an integral applications processor 120′ according to further embodiments of the invention. The UPS 100′ includes power supply circuitry 110′ that selectively provides power from first and second power sources 10a, 10b to an external load. The power supply circuitry 110′ includes power switching circuitry 112 that is controlled by a control processor 114. Such switching and control circuitry may take any of a number of different conventional forms, operations of which are known to those of skill in the art.

As shown in FIG. 2, the control processor 114 is in communication with the applications processor 120′, and may transmit and/or receive power supply-related information to and/or from the applications processor 120′. The applications processor 120′ includes a communications interface 124, e.g., hardware and/or software that enables the operating system 122 of the applications processor 120′ to communicate with one or more external devices over, for example, a wireline, wireless, optical or other data communications network (e.g., Ethernet LAN and/or WAN, cellular wireless network, IEEE 802.11(a)-(g) wireless LAN, or the like). In particular, the communications interface 124 may be operative to support receipt of applications (e.g., applications program code) and receipt and/or transmission of related data, as well as to support receipt and transmission of UPS commands and UPS status information, respectively, related to operation of the power supply circuitry 110′. For example, applications developers may use the communications interface 124 to download to the applications processor 120′ the various respective application programs that control their respective applications. The UPS 100′ thus may provide a general-purpose high-availability computing platform that may be used by a variety of different end users for a variety of different applications.

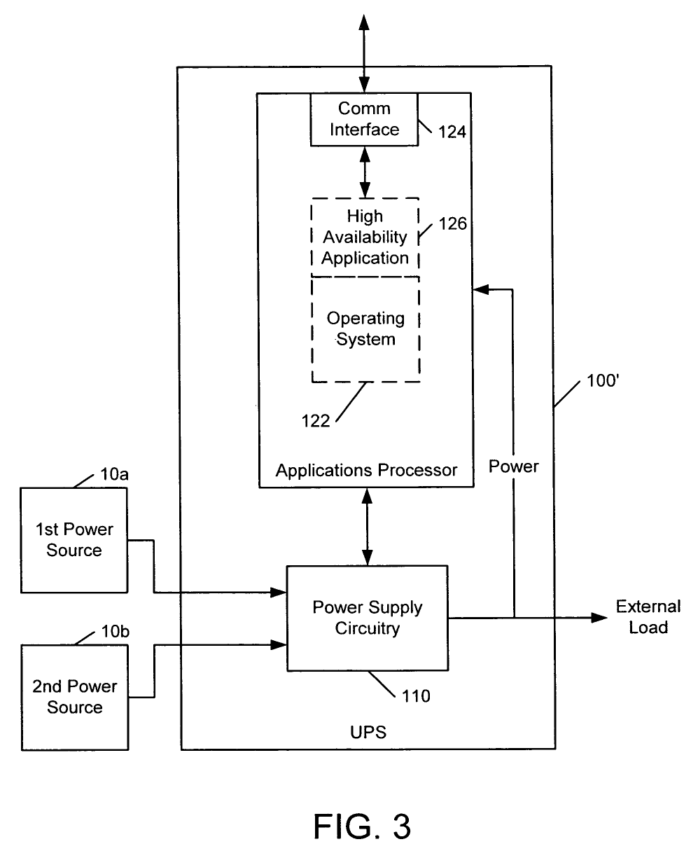

For example, FIG. 3 illustrates an exemplary application of a UPS 100′ along the lines described with reference to FIG. 2 for a high availability network application 126. In particular, the high availability network application 126, such as a packet sniffer or other data integrity/security application, may be loaded on the applications processor 120′ via the communications interface 124, and execute on the operating system 122. Application-related information may be communicated between the application 126 and an external source/recipient via the communications interface 124. Such a configuration may be useful, for example, in networking applications, where the UPS 100′ may serve as an “always there” node that can provide high availability network management functions, such as fault recovery management.

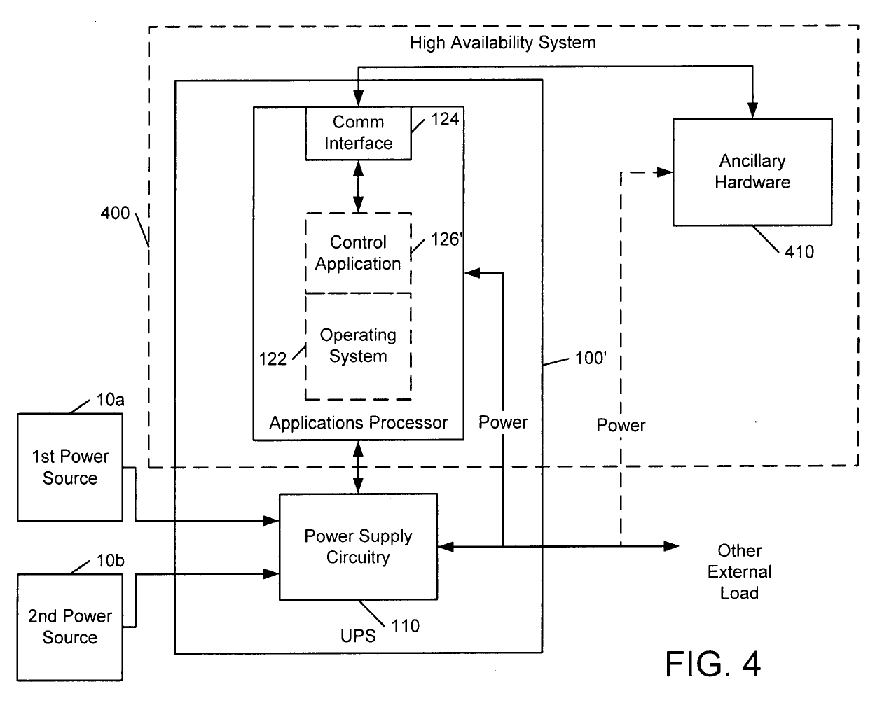

FIG. 4 illustrates another exemplary use of a UPS 100′ along lines described above with reference to FIG. 2 to provide a controller for a high availability system 400, such as a security system, a traffic management system, or the like. The system 400 includes a control application 126′ executing on the operating system 122 provided by the applications processor 120′ of the UPS 100′. As shown, the system 400 further includes ancillary hardware 410, e.g., other hardware monitored and/or controlled by the control application 126′. In a security application, for example, the ancillary hardware 410 might include cameras, sensors, and/or recorders. As shown, such ancillary hardware 410 may be powered by the power supply circuitry 110 of the UPS 100′.

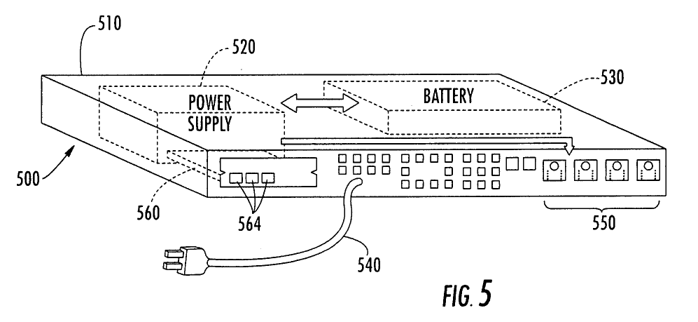

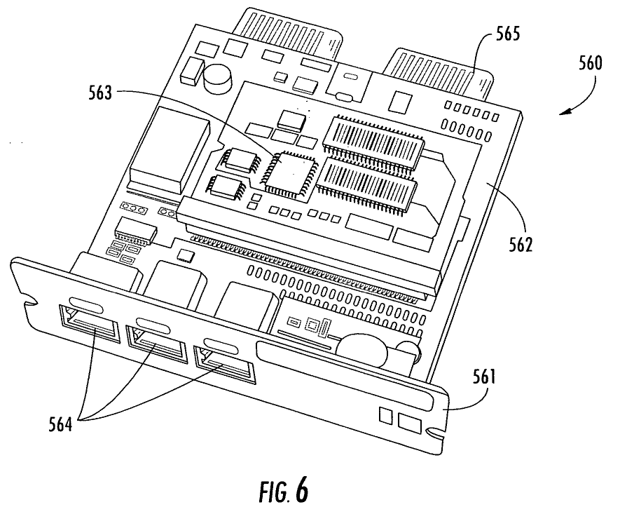

FIG. 5 illustrates a UPS 500 according to further embodiments of the invention, with an integral applications processor 560 implemented as a removable circuit card configured to be installed in the UPS 500. The UPS 500 includes a housing 510 that contains power supply circuitry 520 that is configured to selectively power external load outlets 550 from an AC power supply, i.e., via an AC power cord 540, and a backup power supply, i.e., an internally-mounted battery 530. As shown in FIGS. 5 and 6, the applications processor 560 is implemented in a circuit card assembly 562 having an edge connector 565 configured to be connected to a control bus (not shown) of the UPS 500. The circuit card assembly 562 includes a microprocessor 563 and associated memory, control and communications circuitry, including circuitry configured to support communications with external devices via Ethernet connectors 564 mounted on a faceplate 561. Although not shown in FIG. 5, the applications processor 560 may include additional ancillary components, such as mass storage (e.g., a disk drive).

The illustrated processor 560 of FIG. 5 is configured to support a dual Ethernet interface, and provides an operating system (in the illustrated example, Linux) that supports loading and execution of applications programs. The processor 560 is further operative to communicate UPS status and control information between the Ethernet ports 514 and the control bus of the UPS 500. It will be appreciated that, in alternative embodiments, an applications processor may be implemented on the same circuit board or card assembly(s) as a UPS's power supply circuitry (e.g., on the same circuit board as the UPS control processor), rather than on a separate, removable card.

In the drawings and specification, there have been disclosed typical exemplary embodiments of the invention and, although specific terms are employed, they are used in a generic and descriptive sense only and not for purposes of limitation, the scope of the invention being set forth in the following claims.

That which is claimed:

1. An uninterruptible power supply (UPS) comprising power supply circuitry configured to selectively provide power to an external load from a plurality of power sources, and an applications processor integrated within the UPS and powered by the power supply circuitry, the applications processor configured to provide an operating system that supports loading and execution of externally-supplied applications.

2. A UPS according to claim 1, wherein the applications processor is configured to provide a communications interface.

3. A UPS according to claim 2, wherein the applications processor is configured to load applications via the communications interface.

4. A UPS according to claim 2, wherein the power supply circuitry is controllable via the communications interface.

5. A UPS according to claim 1, wherein the power supply circuitry comprises a control processor, and wherein the applications processor is operative to communicate with the control processor.

6. A UPS according to claim 5, wherein the control processor and the applications processor are positioned on a common circuit board.

7. A UPS according to claim 5, wherein the applications processor is included in a removable circuit card.

8. A UPS according to claim 1, wherein the applications processor is included in a removable circuit assembly.

9. A UPS according to claim 8, wherein the applications processor is configured to provide a communications interface, and wherein the removable circuit assembly includes a network connector that supports the communications interface.

10. A UPS according to claim 1, wherein the power supply circuitry provides AC and/or DC power to the external load.

11. A UPS according to claim 10, wherein the power supply circuitry provides DC power to the applications processor.

12. A UPS according to claim 1, wherein the plurality of alternate power sources includes a battery.

13. A UPS according to claim 12, wherein the battery is included in the UPS.

14. An apparatus, comprising:
a circuit card configured to be installed in a UPS and including an applications processor configured to provide an operating system that supports loading and execution of externally supplied applications.

15. An apparatus according to claim 14, wherein the applications processor is configured to provide a communications interface for the UPS.

16. A UPS according to claim 15, wherein the applications processor is configured to load applications via the communications interface.

17. An apparatus according to claim 15, further comprising a network connector that supports the communications interface.

18. An apparatus according to claim 14, wherein the applications processor is operative to communicate with a power supply control processor of the UPS.

19. An apparatus according to claim 18, wherein the circuit card comprises a connector configured to be connected to a control bus of the UPS and wherein the applications processor is configured to communicate with the power supply control processor via the control bus.
